(19) United States
(12) Patent Application Publication
(10) Pub. No.: US 2026/0005632 A1
(43) Pub. Date: Jan. 1, 2026

(54) METHOD FOR OPERATING A FIELD-GUIDED ELECTRIC MOTOR

(71) Applicant: Andreas Stihl AG & Co. KG, Waiblingen (DE)

(72) Inventors: Jan Lukas Jackenkroll, Waiblingen (DE); Simon Dietrich, Waiblingen (DE); Ingo Kugler, Waiblingen (DE)

(21) Appl. No.: 18/981,287

(22) Filed: Dec. 13, 2024

(30) Foreign Application Priority Data
Jun. 27, 2024 (DE) 10 2024 118 232.6

(51) Int. Cl. H02P 21/36; H02P 21/22

(52) U.S. Cl. CPC H02P 21/36; H02P 21/22

(57) ABSTRACT

A method and a device are for operating a field-guided electric motor on a battery pack. In a motor mode, the motor current includes a field-forming motor current component and a torque-forming motor current component, which form a current amplitude of the motor current. In order to brake the electric motor fast with the option of possibly switching over to accelerating the electric motor at any time, provision is made for dividing the braking mode into two temporally separate braking sections. In a first braking section, the current amplitude of the motor current is kept constant by adjusting the field-forming motor current component. In a second braking section, the current amplitude of the motor current is variable. The switching of the braking mode over from the first braking section to the second braking section takes place when there is a fall below a predetermined speed of the electric motor.

### CROSS-REFERENCE TO RELATED APPLICATIONS

This application claims priority of German patent application no. 10 2024 118 232.6, filed Jun. 27, 2024, the entire content of which is incorporated herein by reference.

### TECHNICAL FIELD

The disclosure relates to a method for operating a field-guided electric motor that is operated using a control arrangement on at least one battery pack with a supply voltage. The electric motor has a stator and a rotor, wherein the stator carries a plurality of field windings. In a motor mode, to form a driving electromagnetic rotary field, the field windings are energized by the control arrangement from the battery pack, depending on the rotary position of the rotor, wherein the amplitude of the motor current is composed of a first field-forming motor-current component i_{d} and a second moment-forming motor-current component i_{q}. In a recuperative braking mode, the voltages induced in the field windings of the stator when the rotor is running bring about a torque-forming motor-current component i_{q} which determines the braking torque and from which a recuperation current for regenerative power can be discharged into the battery pack. The recuperation current is supplied to the battery pack for charging.

### BACKGROUND

The charging of a battery pack is dependent, inter alia, on its capacity and its characteristics, that is, a battery pack has, for example, a maximum permitted discharge current and a maximum permitted charging current. Characteristics of this type are also dependent on the construction of the individual cells used in the battery pack, the type of the individual cells (lithium-ion, lithium-polymer, lithium-iron or else nickel metal hydride or similar energy storage devices), the temperature of the battery pack and similar parameters.

In a recuperative mode of the electric motor, the recuperation current flowing for charging the battery pack cannot exceed a maximum permitted charging current of the battery pack used. The maximum permitted charging current of the battery pack is dependent on the torque-forming motor current component for braking the rotor. At the same time, the variable of the torque-forming motor current component for braking the rotor also determines the run-down time of the electric motor until its standstill however.

If an electrical work apparatus is operated using a tool, corresponding run-down times of the electric motor until standstill are established. During operation of the work apparatus, the user often interrupts their work only briefly, for example to change the working position. As soon as the user lets go of the operating element (also referred to as throttle), the control arrangement enters the electrical braking mode. However, before the tool or the electric motor comes to a standstill, the user activates the operating element anew (opens the throttle) in order to continue their work. As the electric motor is in braking mode, there may be time delays until renewed acceleration, which the user perceives as annoying.

### SUMMARY

It is an object of the disclosure to specify a method for operating a field-guided electric motor, which on the one hand allows a rapid braking of the electric motor to a standstill, but on the other hand allows switching over to acceleration of the electric motor at any time during the braking mode.

The aforementioned object is, for example, achieved via a method for operating a field-guided electric motor having a control arrangement for operating the electric motor on at least one battery pack with a supply voltage; the electric motor having a stator and a rotor, the stator carrying a plurality of field windings; in a motor mode, to form a driving electromagnetic rotary field, the field windings are configured to be energized by the control arrangement from the battery pack in dependence upon a rotary position of the rotor; wherein a flowing motor current is composed of a first field-forming motor current component and a second torque-forming motor current component, and forms a current amplitude; in a braking mode of the electric motor, voltages induced in the field windings of the stator when the rotor is rotating are configured to bring about the second torque-forming motor current component for braking the rotor; the braking mode including at least two temporally separate braking sections including a first braking section and a second braking section; in the first braking section, the current amplitude of the motor current is constant due to adjustment of the first field-forming motor current component; and, in the second braking section, the current amplitude of the motor current is variable. The method includes: switching the braking mode over from the first braking section to the second braking section when the electric motor falls below a predetermined speed.

The aforementioned object is, for example, achieved via a device for carrying out a method for operating a field-guided electric motor having a stator, a rotor, at least one battery pack for operating the electric motor using a motor current having a current amplitude, the electric motor further having a control arrangement for setting the current amplitude of the motor current, the control arrangement being electrically connected to the electric motor and the at least one battery pack; wherein the stator carries a plurality of field windings arranged to form an electromagnetic rotary field, and the control arrangement is configured, in a motor mode, to energize the field windings of the stator in a driving manner in a rotational direction in dependence upon a rotary position of the rotor, and the control arrangement is configured to set the motor current flowing in the field windings of the stator in a braking mode. The device includes: a converter configured to detect a plurality of currents of the electromagnetic rotary field, which is multi-phased, flowing in the field windings as vectors of the rotary field and electronically transform the plurality of currents into the motor current in two-dimensional representation, wherein the motor current of the two-dimensional representation includes a first field-forming motor current component and a second torque-forming motor current component; a control element for setting the motor current components in the two-dimensional representation of the motor current in dependence upon an operating state of the electric motor such that, in the braking mode of the electric motor, in at least one first braking section, a current amplitude of the motor current is constant due to adjustment of the first field-forming motor current component and at least in a second, temporally separate, braking section, the current amplitude of the motor current is variable; and, a switchover device configured, when the electric motor falls below a predetermined speed, to switch over from the at least one first braking section to the at least one second braking section of the braking mode.

According to the disclosure, the braking mode of the electric motor is divided into at least two temporally separate braking sections. In a first braking section, the current amplitude of the motor current is kept constant by adjusting the field-forming motor current component. In a second braking section, the current amplitude of the motor current is variable. Switching of the braking mode over from the first braking section to the second braking section takes place when there is a fall below a predetermined speed of the electric motor.

In this optimized braking behavior, a constant motor current amplitude is set. The division between a torque-forming motor current component i_{q} and a field-forming motor current component i_{d} is chosen such that in the first braking section, the current amplitude of the motor current is constant. This motor current can be used as recuperation current for charging the battery pack. Only from a predetermined speed limit is there a switch over to the second braking section with a variable current amplitude.

According to the method according to the disclosure, it is ensured using a control arrangement for operating the electric motor in braking mode that the current amplitude is constant in the first braking section. In spite of the limiting of the current amplitude of the motor current, a fast and effective braking of the electric motor is possible within a predetermined braking time. At the same time, it is possible to switch over to an acceleration of the electric motor at any time during the braking mode. By varying the field-forming first motor current component i_{d} such that it is not equal to zero, the torque-forming motor current component i_{q} is set directly in terms of its size and in the process, a field-forming current flow is generated at the same time, which causes an electrical power loss in the stator. This ohmic power loss caused by the field-forming motor current component i_{d} increases the braking power of the electric motor so that, without increasing the recuperation current, which is dependent on the torque-forming motor current component i_{q}, above the predetermined limit value, an increased controlled braking power is available, which ensures fast braking of the electric motor and thus of the tool within a predetermined braking time.

The variable of the current amplitude in the first braking section is particularly set depending on the temperature of a control arrangement and/or the electric motor. The temperature of the electric motor is determined at the winding and/or at the permanent magnet. The temperature of the control arrangement is determined at the electronic switching elements. Also expedient is the setting of the variable of the current amplitude depending on the variable of a supply voltage that is applied at the electric motor. The current amplitude is very particularly set depending on an inductance of the electric motor and/or a concatenated magnetic flux of the electric motor.

In further embodiment of the disclosure, in the first braking section, the field-forming motor current component i_{d} of the motor current is set to be not equal to zero. This can be used in particular to limit a recuperative regenerative power to the battery pack by adjusting the field-forming motor current component i_{d}. If the recuperation current for charging the battery pack approaches the predetermined limit value, influence is exercised on the field-forming second motor current component i_{d} and this changes. If the recuperation current for charging the battery pack tends to exceed a predetermined limit value, the field-forming motor current component i_{d} is set to be not equal to zero in such a manner that the predetermined limit value of the recuperation current for charging the battery pack is not exceeded. In further embodiment of the disclosure, provision is made for the setting of the field-forming first motor current component i_{d} to take place in the braking mode in such a manner that in the braking mode of the electric motor, for the same recuperative regenerative power P_{battery} into the battery pack, the braking power of the electric motor increases. In particular, in the braking mode, when the speed is falling, the field-forming first motor current component i_{d} decreases, the second torque-forming motor current component i_{q} increases.

It may be advantageous if the first braking section has a time duration that is greater than or equal to the time duration of the second braking section. In particular, a ratio of the time duration of the first braking section to the time duration of the second braking section is a maximum of 10 to 1, in particular a maximum of 4 to 1, in particular a maximum of 3 to 1, in particular a maximum of 2 to 1 and in particular a minimum of 1 to 1.

In one possible embodiment of the method, during operation of the field-guided electric motor, a three-phase rotary field is built up, wherein the currents iₐ, i_{b}, i_{c} of the three-phase rotary field flowing in the field windings are detected as vectors of the rotary field. These detected vectors of the rotary field are electronically transformed into a motor current in two-dimensional representation. The motor current of the two-dimensional representation, which is composed of the first field-forming motor current component i_{d} and a second torque-forming motor current component i_{q} that determines the braking torque, is set in such a manner that, in the braking mode of the electric motor, the field-forming second motor current component i_{d} is not equal to zero, for example, greater than zero or less than zero. The setting preferably takes place in such a manner that the first field-forming motor current component i_{d} is set in such a manner that the recuperation current for charging the battery pack does not exceed a predetermined limit value. After setting the field-forming first motor current component i_{d} in the two-dimensional representation, the values are transformed back into the three-phase rotary field and the electric motor is switched on via the control arrangement.

A device for carrying out the method for braking a field-guided electric motor made of a stator and a rotor includes a battery pack for operating the electric motor via a control arrangement for setting the motor current, which is provided between the electric motor and the battery pack. The stator of the electric motor carries a plurality of field windings, particularly three field windings that are offset at an electrical angle of 120° with respect to one another, which field windings are arranged to form an electromagnetic rotary field. The control arrangement is designed, in the motor mode, to energize the field windings of the stator in a driving manner in the rotational direction depending on the rotary position of the rotor, and further, in the braking mode, to supply the motor current that arises owing to the voltages induced in the field windings of the stator to the battery pack as regenerative power for charging. The control arrangement has a converter that is designed to detect the currents iₐ, i_{b}, i_{c} of the multiphase rotary field flowing in the field windings as vectors of the rotary field and electronically transform them into a motor current in two-dimensional representation. The motor current of the two-dimensional representation includes a field-forming first motor current component i_{d} and a second torque-forming motor current component i_{q} that determines the braking torque. The control arrangement has a control element that is suitable for setting the motor current components of the two-dimensional motor current depending on the operating state of the electric motor and on predetermined limit values in such a manner that, in the braking mode of the electric motor, in at least one first braking section, a current amplitude of the motor current is constant due to adjustment of the field-forming motor current component and at least in a second, temporally separate, braking section, the current amplitude of the motor current is variable, wherein a switchover device is provided, which is suitable, when there is a fall below a predetermined speed of the electric motor, to switch over from the at least one first braking section to the at least one second braking section of the braking mode.

In particular, the control arrangement is designed to set a variable of the current amplitude depending on a temperature of the control arrangement and/or the electric motor. The control arrangement is designed expediently to set the variable of the current amplitude depending on the variable of a supply voltage that is applied at the electric motor. Very particularly, the control arrangement is designed to set the current amplitude depending on an inductance of the electric motor and/or a concatenated magnetic flux of the electric motor.

In further embodiment of the device, the control arrangement is designed, in the at least one first braking section, to set the field-forming motor current component of the motor current to be not equal to zero via the control element.

It can be advantageous to configure the control arrangement in such a manner that a recuperative regenerative power into the battery pack is limited by adjusting the field-forming motor current component via the control element. Provision may be made for setting the field-forming first motor current component using the control arrangement in the braking mode in such a manner that, in the braking mode of the electric motor with the same recuperative regenerative power into the battery pack, a braking power of the electric motor increases.

In further embodiment of the disclosure, the control arrangement is designed to operate the electric motor for a time duration in the first braking section, wherein the time duration of the first braking section is greater than or equal to a time duration of the second braking section.

The field-guided electric motor is designed to build up a three-phase rotary field during operation. The currents of the three-phase rotary field flowing in the field windings are detected as vectors of the rotary field and electronically transformed into a motor current in two-dimensional representation. The motor current in two-dimensional representation composed of the first field-forming motor current component and the second torque-forming motor current component is set via the control element in such a manner that, in the braking mode of the electric motor, the field-forming motor current component is not equal to zero.

The electric motor can be a synchronous motor or else an asynchronous motor.

Advantageously, the electric motor is the drive motor in a handheld work apparatus, particularly in a portable work apparatus. A handheld work apparatus, particularly a work apparatus that is guided along the ground, can be, for example, a lawnmower, a rotary tiller, a cut-off saw or similar work apparatus. Handheld, portable work apparatuses are, for example, chainsaws, cut-off saws, brushcutters or the like, particularly battery-operated work apparatuses.

### BRIEF DESCRIPTION OF DRAWINGS

The invention will now be described with reference to the drawings wherein:

FIG. 1 shows, in a schematic illustration, the basic construction of a circuit arrangement for operating a field-guided electric motor on a battery pack;

FIG. 2 shows a schematic illustration of a field-guided electric motor having field windings that are arranged offset by 120° with respect to one another;

FIG. 3 shows, in a schematic illustration, a brake circuit for setting the braking current that is preferably provided in the control arrangement;

FIG. 4 shows, in a schematic illustration, the electric motor having a motor current as recuperative braking current having a torque-forming motor current component i_{q} and having a field-forming motor current component i_{d} that is set to zero;

FIG. 5 shows a schematic illustration according to FIG. 4 having a recuperative braking current having a torque-forming motor current component i_{q} and having a field-forming motor current component i_{d} that is set such that it is not equal to zero;

FIG. 6 shows, in a schematic illustration, a device for setting the motor current components i_{q} and i_{d} of the motor current in braking mode;

FIG. 7 shows, in a schematic illustration, a braking mode made up of two braking sections with different amplitudes of the motor current; and,

FIG. 8 shows, in a schematic illustration, the motor current flowing in the braking mode, which is composed of a motor current component i_{q} and a motor current component i_{d}.

### DETAILED DESCRIPTION

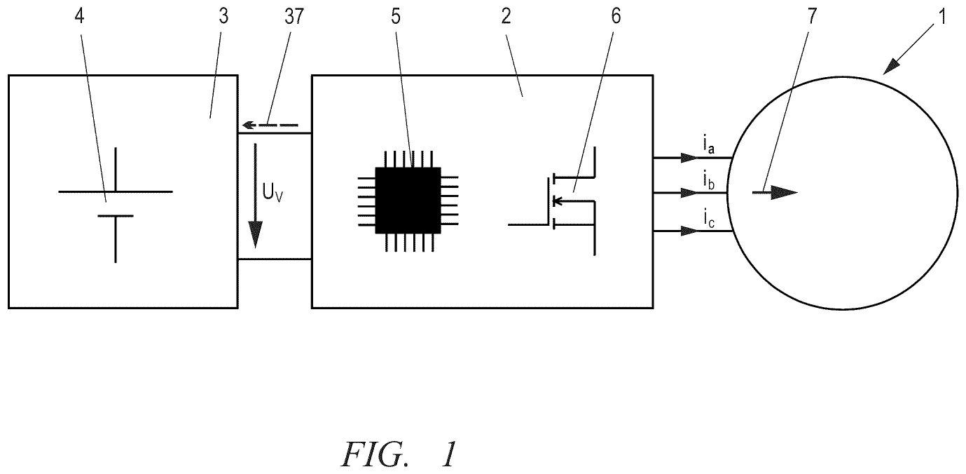

In FIG. 1, a field-guided electric motor 1 is illustrated, which is operated with a supply voltage U_{V} from a battery pack 3 via a control arrangement 2. The control arrangement 2 includes a control unit 5 and electronic switching elements 6. The battery pack 3 includes a multiplicity of individual cells 4 which are electrically interconnected within the battery pack 3 to form a cell composite. The individual cells 4 can be lithium-ion cells, lithium-polymer cells, lithium-iron cells or else individual cells of a different chemical composition, for example, NiCd, NiMh or similar cells.

The control arrangement 2 is connected to the supply voltage U_{V} of the battery pack 3, which is available as DC voltage. A control unit 5, particularly a microprocessor, controls a control circuit made from electronic switching elements 6, particularly MOSFETs. Via corresponding activation of the switching elements 6, a motor current 7 including operating currents iₐ, i_{b} and i_{c} flow to the electric motor 1 that is advantageously configured as a field-guided three-phase electric motor.

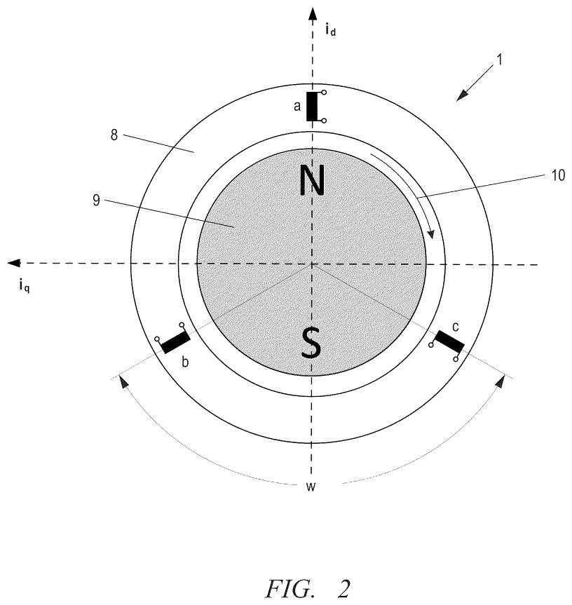

As illustrated in FIG. 2, the electric motor 1 has a stator 8 and a rotor 9. The stator 8 carries field windings a, b and c that are arranged over the circumference of the stator 8 with an angular distance w of 120°. The operating currents iₐ, i_{b} and i_{c} shown in FIG. 1 are assigned to the respective field windings a, b and c. The rotor 9 carries at least one permanent magnet having the magnetic poles N and S. In the motor mode of the electric motor 1, the control unit 5 energizes the field windings a, b and c depending on the rotary position of the rotor 9 to form a driving electromagnetic rotary field in rotational direction 10.

The motor current 7 can fundamentally be divided in motor mode and in braking mode into a first field-forming motor current component i_{d} and a second, torque-forming motor current component i_{q}. The field-forming motor current component i_{d} causes the buildup of the electromagnetic rotary field through the field windings a, b and c, while the motor current component i_{q} brings about a driving torque of the rotor 9. In a broader sense, the motor current component i_{q} brings about an active power and the motor current component i_{d} brings about a blind power of the electric motor 1 in operation. In a two-dimensional vector representation of the motor current components i_{d}, i_{q}, the motor current 7 having a current amplitude A emerges as a vector.

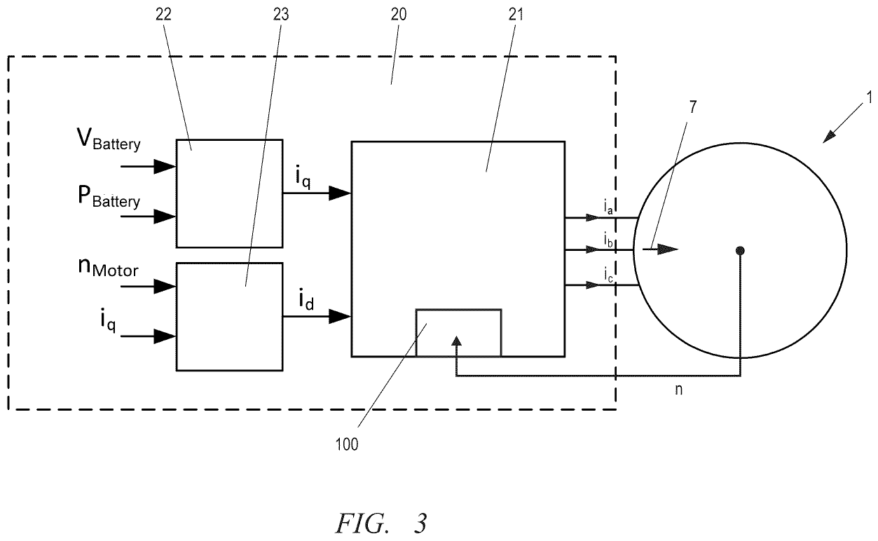

In an embodiment of the control arrangement 2, a brake circuit 20 is provided in this, as is shown by way of example in FIG. 3. The brake circuit 20 can also be provided as a circuit arrangement separate from the control arrangement 2. In FIG. 3, a schematically illustrated brake circuit 20 is connected to the electric motor 1. It includes a control circuit 21 for setting a recuperation current 27, which can also be referred to as a negative motor current 7. The control circuit 21 is connected to a monitoring circuit 22 of the battery pack 3, to which the voltage V_{battery} and the power P_{battery} of the battery pack 3 is communicated. From these variables, the monitoring circuit 22 determines the variable of the maximum permitted recuperation current 27 that may be supplied to the battery pack. The recuperation current 27 of the electric motor 1 (negative motor current 7) is divided into a torque-forming motor current component i_{q} and a loss-forming field-forming motor current component i_{d}. The field-forming motor current component i_{d} is predetermined depending on the motor speed nₘₒₜₒᵣ of the electric motor 1 and the recuperation current 27 determined from the characteristics of the battery pack 3, which recuperation current is derived from the torque-forming motor current component i_{q}. Thus, using the input variables of the motor speed nₘₒₜₒᵣ and the motor current component i_{q} determining the variable of the recuperative recuperation current 27, the field-forming motor current component i_{d} to be set can be read out from a characteristic map or storage 23 and specified for the control circuit 21.

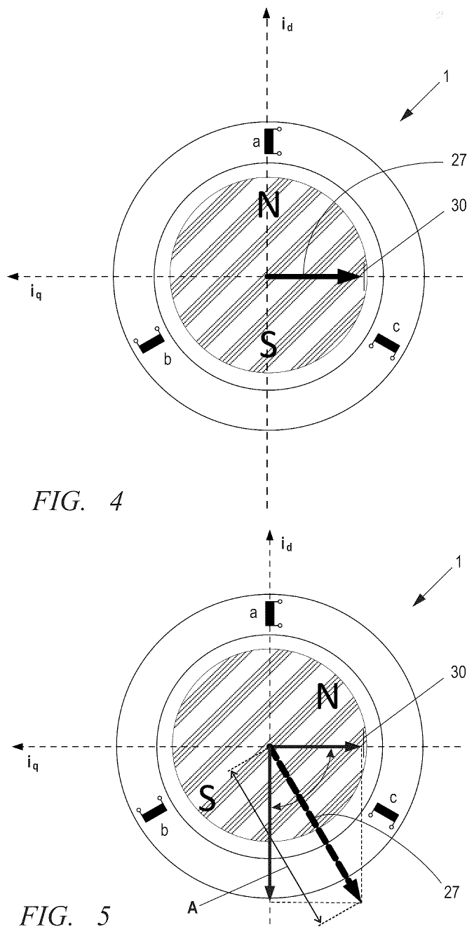

In FIG. 4, the electric motor 1 is illustrated in braking mode in a schematic illustration. The recuperation current 27 that is illustrated as negative motor current is determined exclusively by the torque-forming motor current component i_{q}, as the field-forming motor current component i_{d} is set to zero. The braking time of the electric motor 1 is substantially determined by the recuperation current 27 that corresponds to the torque-forming motor current component i_{q}. The torque-forming motor current component i_{q} determines the recuperation current 27 for charging the battery pack 3. The resulting recuperative regenerative power P_{battery} into the battery pack 3 in braking mode can be estimated approximately according to the following formula:

$${P}_{battery} = const . = 1.5 ( {i}_{q} * p * {Ψ}_{PM} * {ω}_{mech} - R * {i}_{q} \hat{} 2 - R * {I}_{d} \hat{} 2 )$$

$$with {M}^{∼} {i}_{q} and {I}_{d} = 0$$

and the variables:
i₁=torque-forming motor current component
p=number of pairs of poles
Ψ_{PM}=concatenated magnetic flux
ω_{mech}=mechanical angular velocity
R=ohmic resistance of the field windings
I_{d}=field-forming motor current component

For the current amplitude Iₐₘₚ of the electric motor 1 provided with the reference character A, the following applies

$${I}_{amp} < {Ψ}_{PM} / L$$

where L refers to an inductance of the electric motor 1 and Ψ_{PM} refers to the concatenated magnetic flux. The recuperative regenerative power is determined by

$${P}_{battery} = const . = 1.5 * ( p * {i}_{q} * {Ψ}_{PM} * {ω}_{mech} - R * {I}_{amp} \hat{} 2 )$$

where ω_{mech} specifies a mechanical angular velocity.

As the torque-forming motor current component i_{q} is limited by the maximum permitted recuperation current 27 for charging the battery pack 3, the torque-forming motor current component i_{q} cannot be increased as desired to increase the braking power of the electric motor 1. This would be associated with an increase of the recuperation current (charging current) supplied to the battery pack 3 and could therefore lead to electrical overloading of the battery pack 3.

Setting the field-forming motor current component i_{d} in such a manner that the torque-forming motor current component i_{q} does not get too large without exceeding the predetermined limit value of the recuperation current 27 for charging the battery pack 3 and the braking power of the electric motor 1 is nonetheless increased. This is illustrated schematically in FIG. 5.

Owing to the braking mode of the electric motor 1, the torque-forming motor current component i_{q} and the field-forming motor current component i_{d} are located in the negative axis area of the schematic illustration in FIG. 5. The amplitude A of the recuperation current 27 is a composite vector made up of the torque-forming motor current component i_{q} and the field-forming motor current component i_{d}. As FIG. 5 clearly shows, the vector of the recuperation current 27 is clearly greater than the vector of the recuperation current 27 illustrated in FIG. 4. In FIG. 5, the field-forming motor current component i_{d} is chosen to be so large that the torque-forming motor current component i_{q} and therefore the recuperation current 27 for charging the battery pack does not increase above a permitted limit value. Nonetheless, the braking current 27 is clearly greater than in FIG. 4. By setting the variable of the field-forming motor current component i_{d}, a precise setting of the recuperation current 27 for charging the battery pack 3 derived from the torque-forming motor current component i_{q} is ensured when the braking power is high without the maximum permitted charging current into the battery pack being exceeded.

Advantageously, a limit value 30 of the torque-forming motor current component i_{q} can be fixed in such a manner that the recuperation current 27 approximately, in particular precisely, corresponds to a maximum permitted charging current into the battery pack 3.

In the embodiment according to FIG. 5, there is a phase shift 33 of 90° between the torque-forming motor current component i_{q} and the field-forming motor current component i_{d}. The setting of the torque-forming motor current component i_{q} can take place by setting the variable of the field-forming motor current component i_{d}.

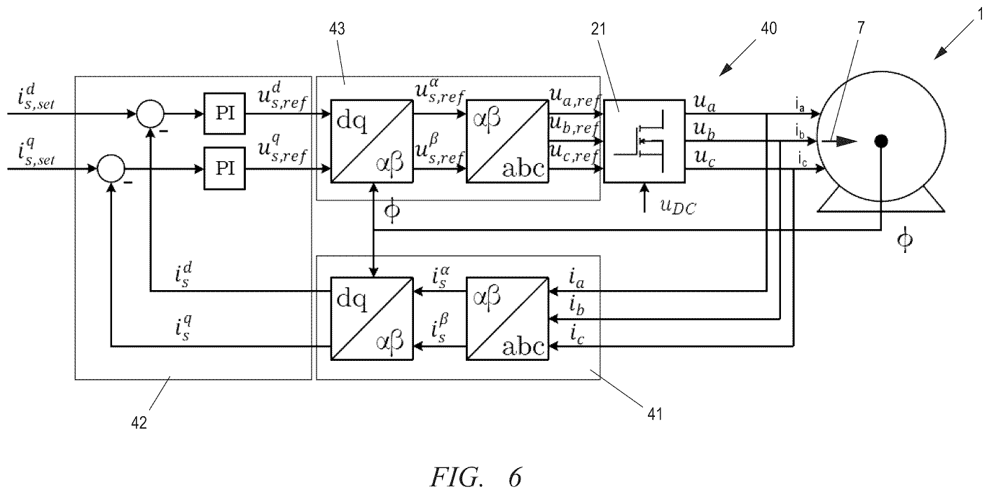

A device 40 for carrying out the method according to the disclosure is reproduced in FIG. 6. The control arrangement 2 controls the rotary field of the electric motor 1 by activating the field windings a, b, c using the activation voltages uₐ, u_{b}, u_{c}, which yields the operating currents iₐ, i_{b}, i_{c} of the field windings a, b, c, in order to drive the rotor in a rotating manner in rotational direction 10 depending on the rotary position of the rotor. The device 40 is designed with a correspondingly designed control arrangement 2 in such a manner that in the braking mode, the voltages induced in the field windings a, b, c of the stator 8 bring about a recuperation current 27 for braking the electric motor 1, the torque-forming motor current component i_{q} of which brings about a recuperative regenerative power P_{battery} into the battery pack 3. To control the motor current components i_{q} and i_{d} of the braking current 27 for the purpose of achieving a high braking power, a converter 41 is provided, which is designed to detect the currents iₐ, i_{b}, i_{c} of the multiphase rotary field flowing in the field coils a, b, c, particularly a three-phase rotary field, as vectors of the rotary field and electronically transform the same into a motor current having the motor current components i_{d}, i_{q} in two-phase representation. The braking current or the motor current is composed of the first field-forming motor current component i_{d} and the second torque-forming motor current component i_{q} that determines the braking torque. The circuit arrangement has a control element 42 which sets the motor current components i_{d}, i_{q} of the two-dimensional braking current 27 depending on the operating state of the electric motor 1 and predetermined set-points i_{dset}, i_{qset} in such a manner that in a braking mode of the electric motor 1 on the one hand, the first field-forming motor current component i_{d} of the recuperation current 27 (braking current) is not equal to zero such that with high regenerative power P_{battery} into the battery pack 3, the braking power of the electric motor 1 increases.

The set-points of the two-dimensional representation predetermined by the control element 42 are transformed back into the three-dimensional representation via a further converter 43 and supplied—for example, as voltage values u_{aref}, u_{bref}, u_{cref}—to the control arrangement 2 for activating the electric motor 1. According to the predetermined voltage values, the control arrangement 2 will set activation voltages uₐ, u_{b}, u_{c}, which leads to the desired recuperation current 27 having the predetermined motor current component i_{q} that brings about the braking torque and the field-forming motor current component i_{d}. This setting of the motor current components i_{d}, i_{q} is permanently monitored and corrected via the values supplied from the converter 41 to the control element 42. The recuperation current 27 used for charging the battery pack is determined by the torque-forming motor current component i_{q}, wherein the limit value of the recuperation current 27 is fixed to the maximum charging current of the connected battery pack 3.

The speed of the electric motor or the rotary position of the rotor 9 of the electric motor is detected and supplied to the converters 41 and 43 for processing.

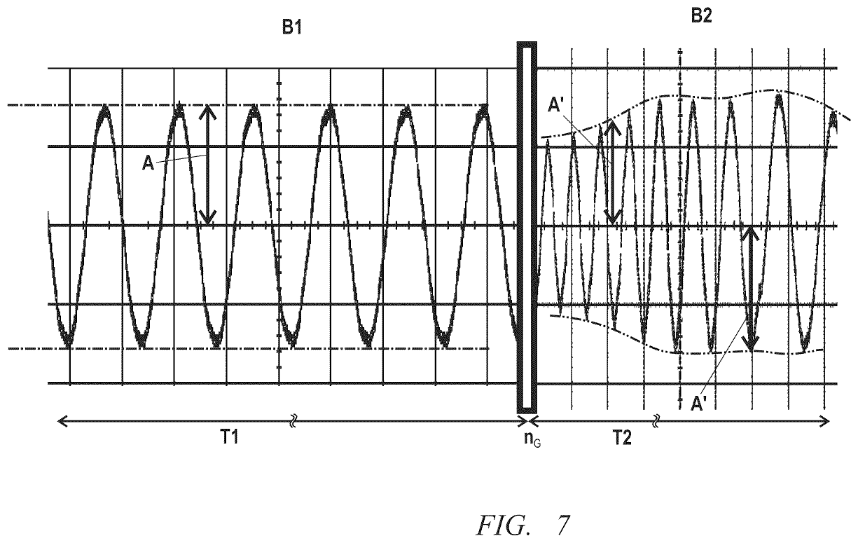

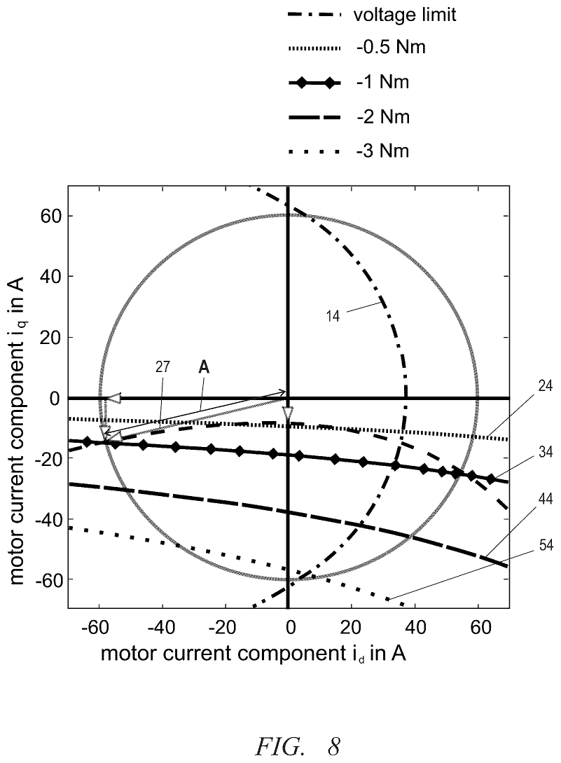

As illustrated in FIG. 7, the braking mode is divided into two operating sections B1 and B2. In the first operation section B1, the amplitude A of the recuperation current 27 is constant over a time duration T1. This is carried out, as illustrated in FIG. 8, by adjusting the field-forming motor current component i_{d}. During the braking mode of the electric motor 1, the speed n will fall until a predetermined limit speed n_{G} is reached or it falls below it. If the limit speed n_{G} is reached or there is a fall below it, the control arrangement 2 or brake circuit 20 that is advantageously integrated in the control arrangement 2 switches over from the first braking section B1 to a second braking section B2 via a switchover device 100 (FIG. 3). In the second braking section B2, the current amplitude A′ is variable.

The predetermined speed n_{G} is selected from a value range of a minimum of 10% of an idling speed of the electric motor 1 and a maximum of 40% of the idling speed of the electric motor 1. Before the start of the braking mode, the electric motor 1 is driven with an operating speed. There is a fall below the predetermined speed n_{G} in terms of time after the expiration of the first braking section B1. During the first braking section B1, the speed n falls until the predetermined speed n_{G} is reached and in particular there is a fall below it. In particular, the time duration T1 of the first braking section B1 is determined by the time period of braking from the operation of the electric motor 1 with the operating speed until there is a fall below the predetermined speed n_{G}. The time duration T2 of the second braking section B2 is determined by the time period from the switchover from the first braking section B1, when there is a fall below the predetermined speed n_{G}, until the standstill of the electric motor.

The first braking section B1 has a time duration T1 that is greater than or equal to the time duration T2 of the second braking section B2. In particular, a ratio of the time duration T1 of the first braking section B1 to the time duration T2 of the second braking section B2 is a maximum of 10 to 1, in particular a maximum of 4 to 1, in particular a maximum of 3 to 1, in particular a maximum of 2 to 1 and in particular a minimum of 1 to 1.

The variable of the current amplitude A of the recuperation current 27 set via the motor current components i_{q} and i_{d} is set depending on the temperature of the control arrangement 2 or the brake circuit 20 and/or the electric motor 1. The temperature of the electric motor 1 is sensed at the winding and/or at the permanent magnet. The temperature of the control arrangement 2 or the brake circuit 20 is sensed at the electronic switching elements.

Additionally or alternatively, the variable of the current amplitude A can be set depending on the variable of the supply voltage that is applied at the electric motor 1. The current amplitude A can also be set depending on an inductance of the electric motor 1 and/or a concatenated magnetic flux of the electric motor 1. In particular, the field-forming motor current component i_{d} of the motor current is set depending on properties of the electric motor 1.

In the first braking section B1, the field-forming motor current component i_{d} of the recuperation current 27 is set not to be equal to zero, as illustrated in FIG. 8. The recuperative regenerative power P_{battery} into the battery pack 3 is limited by adjusting the field-forming motor current component i_{d}. The braking torque is limited by the torque-forming motor current component i_{q}.

In braking mode, the setting of the field-forming first motor current component i_{d} takes place in such a manner that in the braking mode of the electric motor 1, for the same recuperative regenerative power P_{battery} into the battery pack 3, the braking power of the electric motor 1 increases. FIG. 8 shows the limits and the braking power of the method according to the disclosure. The voltage limit is illustrated with the reference character 14. The curve 24 specifies a braking force of 0.5 Nm. The curve 34 specifies a braking force of 1 Nm. The curve 44 specifies a braking force of 2 Nm. The curve 54 specifies a braking force of 3 Nm. The amplitude A of the recuperation current 27 (braking current) is set accordingly by adjusting the motor current components i_{q} and i_{d}.

It is understood that the foregoing description is that of the preferred

embodiments of the invention and that various changes and modifications may be made thereto without departing from the spirit and scope of the invention as defined in the appended claims.

1. A method for operating a field-guided electric motor having a control arrangement for operating the electric motor on at least one battery pack with a supply voltage; the electric motor having a stator and a rotor, the stator carrying a plurality of field windings; in a motor mode, to form a driving electromagnetic rotary field, the field windings are configured to be energized by the control arrangement from the battery pack in dependence upon a rotary position of the rotor; wherein a flowing motor current is composed of a first field-forming motor current component and a second torque-forming motor current component, and forms a current amplitude; in a braking mode of the electric motor, voltages induced in the field windings of the stator when the rotor is rotating are configured to bring about the second torque-forming motor current component for braking the rotor; the braking mode including at least two temporally separate braking sections including a first braking section and a second braking section; in the first braking section, the current amplitude of the motor current is constant due to adjustment of the first field-forming motor current component; and, in the second braking section, the current amplitude of the motor current is variable; the method comprising:
switching the braking mode over from the first braking section to the second braking section when the electric motor falls below a predetermined speed.

2. The method of claim 1 further comprising setting a variable of the current amplitude in dependence upon a temperature of at least one of a control arrangement and the electric motor.

3. The method of claim 1 further comprising setting a variable of the current amplitude in dependence upon a variable of a supply voltage applied at the electric motor.

4. The method of claim 1, wherein the current amplitude is set in dependence upon at least one of an inductance of the electric motor and a concatenated magnetic flux of the electric motor.

5. The method of claim 1, wherein, in the first braking section, the first field-forming motor current component of the motor current is set to be not equal to zero.

6. The method of claim 1, wherein a recuperative regenerative power into the battery pack is limited by adjusting the first field-forming motor current component.

7. The method of claim 6 wherein, in the braking mode, the setting of the first field-forming motor current component takes place such that in the braking mode of the electric motor, for the same recuperative regenerative power into the battery pack, a braking power of the electric motor increases.

8. The method of claim 1, wherein the first braking section has a time duration greater than or equal to a time duration of the second braking section.

9. The method of claim 1, wherein during operation of the field-guided electric motor, a three-phase rotary field is built up, wherein a plurality of currents of the three-phase rotary field flowing in the field windings are detected as vectors of the rotary field and electronically transformed into the motor current in two-dimensional representation; the motor current of the two-dimensional representation, which is composed of the first field-forming motor current component and the second torque-forming motor current component, is set such that in the braking mode of the electric motor, the first field-forming motor current component is not equal to zero.

10. A device for carrying out a method for operating a field-guided electric motor having a stator, a rotor, at least one battery pack for operating the electric motor using a motor current having a current amplitude, the electric motor further having a control arrangement for setting the current amplitude of the motor current, the control arrangement being electrically connected to the electric motor and the at least one battery pack; wherein the stator carries a plurality of field windings arranged to form an electromagnetic rotary field, and the control arrangement is configured, in a motor mode, to energize the field windings of the stator in a driving manner in a rotational direction in dependence upon a rotary position of the rotor, and the control arrangement is configured to set the motor current flowing in the field windings of the stator in a braking mode, the device comprising:
a converter configured to detect a plurality of currents of the electromagnetic rotary field, which is multi-phased, flowing in the field windings as vectors of the rotary field and electronically transform the plurality of currents into the motor current in two-dimensional representation, wherein the motor current of the two-dimensional representation includes a first field-forming motor current component and a second torque-forming motor current component;
a control element for setting the motor current components in the two-dimensional representation of the motor current in dependence upon an operating state of the electric motor such that, in the braking mode of the electric motor, in at least one first braking section, a current amplitude of the motor current is constant due to adjustment of the first field-forming motor current component and at least in a second, temporally separate, braking section, the current amplitude of the motor current is variable; and,
a switchover device configured, when the electric motor falls below a predetermined speed, to switch over from the at least one first braking section to the at least one second braking section of the braking mode.

11. The device of claim 10, wherein the control arrangement is configured to set a variable of the current amplitude in dependence upon at least one of a temperature of the control arrangement and a temperature of the electric motor.

12. The device of claim 10, wherein the control arrangement is configured to set a variable of the current amplitude in dependence upon on a variable of a supply voltage that is applied at the electric motor.

13. The device of claim 10, wherein the control arrangement is configured to set the current amplitude in dependence upon at least one of an inductance of the electric motor and a concatenated magnetic flux of the electric motor.

14. The device of claim 10, wherein the control arrangement is configured, in the at least one first braking section, to set the first field-forming motor current component of the motor current, via the control element, to be not equal to zero.

15. The device of claim 10, wherein the control arrangement is configured to limit a recuperative regenerative power into the battery pack by adjusting the first field-forming motor current component via the control element.

16. The device of claim 15, wherein the control arrangement is configured to set the first field-forming motor current component in the braking mode such that, in the braking mode of the electric motor, with a same recuperative regenerative power into the battery pack, a braking power of the electric motor increases.

17. The device of claim 10, wherein the control arrangement is configured to operate the electric motor for a first time duration of the first braking section, wherein the first time duration of the first braking section is greater than or equal to a second time duration of the second braking section.

18. The device of claim 10, wherein:
the field-guided electric motor is configured to build up a three-phase rotary field during operation;
the plurality of currents of the three-phase rotary field flowing in the field windings are detected as vectors of the rotary field and electronically transformed into the motor current in two-dimensional representation;
the motor current of the two-dimensional representation, which includes the first field-forming motor current component and the second torque-forming motor current component, is set via the control element such that in the braking mode of the electric motor, the field-forming motor current component is not equal to zero.
